(19) United States
(12) Patent Application Publication
(10) Pub. No.: US 2002/0007362 A1
(43) Pub. Date: Jan. 17, 2002

(54) Apparatus and Method for Facilitating Agreement Over a Network

(75) Inventors: Mr. Eric Collins, Cambridge, MA (US); Mr. Alan Price, Cambridge, MA (US)

Correspondence Address: Bromberg & Sunstein, LLP, 125 Summer Street, Boston, MA, 02110, US, 617-443-9292, 617-443-0004

(73) Assignee: THOUGHTBRIDGE, Cambridge, 02138 (US)

(21) Appl. No.: 09/561,043

(22) Filed: Apr. 28, 2000

Related U.S. Application Data
(60) Provisional application No. 60/131,960, filed on Apr. 30, 1999.
(60) Provisional application No. 60/141,182, filed on Jun. 25, 1999.
(60) Provisional application No. 60/148,605, filed on Aug. 12, 1999.

(51) Int. Cl. G06F 7/00

(52) U.S. Cl. 707/5

(57) ABSTRACT

### Abstract of Disclosure

Systems, methods, and computer program products for facilitating agreement pertaining to a situation over a network among a plurality of parties are disclosed. First, position data is received from each of a plurality of parties over the network, and the position data is stored. Next, a set of resolutions is retrieved, the set having at least one member, from a database containing resolutions and associated statistical data, the set of resolutions being based upon the combined position data presented by the plurality of parties. The retrieved set of resolutions is sent to each of the plurality of parties. Further, the situation may comprise a plurality of issues, each requiring a separate resolution. A plurality of retrieved sets of resolutions are sent to each of the plurality of parties in the form of one or more templates. Refinement of the issues may occur by either of the parties which will cause an alternative set of resolutions based on additional data provided by at least one of the parties. Each issue which is part of the situation may be refined and a new set of resolutions provided. The issues are refined until an agreement is reached or the parties determine that an alternative dispute mechanism is required. If an alternative dispute mechanism is selected resultant communications between the parties are provided to either a mediator or an arbitrator.

### Cross Reference to Related Applications

This application claims priority from co-pending U.S. provisional patent application serial number 60/131,960, filed April 30, 1999, entitled "APPARATUS AND METHOD FOR FACILITATING AGREEMENT OVER A NETWORK" and bearing attorney docket number 2316/101, U.S. provisional patent application serial number 60/141,182, filed June 25, 1999, entitled "APPARATUS AND METHOD FOR FACILITATING AGREEMENT OVER A NETWORK" and bearing attorney docket number 2316/102, and U.S. provisional patent application 60/148,605, filed August 12, 1999, entitled "APPARATUS AND METHOD FOR FACILITATING AGREEMENT OVER A NETWORK" and bearing attorney docket number 2316/103, the disclosures of which are incorporated herein, in their entirety, by reference.

### Technical Field and Background of Invention

### Technical Field

The present invention relates to devices and methods of network communications and processing, and in particular to those facilitating an agreement over a network.

### Background Art

The prior art is rich in the area of network communications and processing. A wide range of systems promote group work over networks. In addition, it is known in the art to attempt to use a computer for dispute resolution to quantify data supposed to represent conflicting positions to a dispute with a view to suggesting a resolution of the dispute. Efforts such as this have met with at best only partial success. One prior art system allows parties wishing to reach an agreement to submit a plurality of blind settlement offers. Once the data has been entered, the system automatically determines whether an agreement is possible. Thus, the system may not produce a resolution in a substantial number of cases. Also, this system is limited to situations involving resolution of only one issue, and more particularly, an issue involving a monetary amount. Another prior art system is capable of resolving a situation involving a plurality of issues. This system requires each party to rank the relative importance of each issue and to specify satisfaction levels corresponding to preferences associated with various possible resolutions to the situation. However, the set of possible resolutions to the situation is confined to resolutions based on the input of the parties.

### Summary of Invention

In one embodiment, a method for facilitating agreement pertaining to a situation over a network among a plurality of parties is disclosed. First, position data is received from each of the plurality of parties over the network, and the position data is stored. Next, a set of resolutions is retrieved, the set having at least one member, from a database containing resolutions and associated statistical data, the set of resolutions being based upon the combined position data presented by the plurality of parties. The retrieved set of resolutions is sent to each of the plurality of parties. Further, the situation may comprise a plurality of issues, each requiring a separate resolution. A plurality of retrieved sets of resolutions is sent to each of the plurality of parties. In a related embodiment, the plurality of retrieved sets of resolutions is sent to each of the plurality of parties in the form of a plurality of templates. In yet another related embodiment, alternative sets of resolutions which are tailored based on additional data provided by at least one of the parties are interactively retrieved. The method may be further refined by producing an agreement based upon resolutions agreed to by each of the parties.

In an alternative embodiment, a system for negotiating a situation among a plurality of parties connected to a network is disclosed. The system may include a processor connected to the network for receiving position data, the position data being representative of a position with respect to an issue pertinent to a situation, from each of the plurality of parties. The system may also include a digital storage medium, in communication with the processor, having a database containing statistical data of possible resolutions which may be accessed by the processor based upon the combined position data presented by the plurality of parties. The storage medium passes the resolutions associated with the statistical data to the processor and the processor sends the resolutions to each of the plurality of parties. In a related embodiment, the system further comprises a negotiation log composed of multiple fields for storing position data sent by the parties. In another related embodiment, the system further includes a plurality of computer nodes coupled to the network for sending data and receiving resolutions from the processor, each computer node being operated by one of the plurality of parties.

In another alternative embodiment, a data arrangement of computer readable code on a computer readable medium for providing a negotiation history is disclosed. The data arrangement may include a plurality of fields for use with a database for containing position data, the position data being representative of a position with respect to at least one issue pertinent to a situation, for each of a plurality of parties through stages of a negotiation in a computer-based negotiation process and an output template for use with the fields that arranges the fields in chronological order.

In yet another alternative embodiment, a method of facilitating agreement, pertaining to a situation over a network among a plurality of parties is disclosed. First, data identifying the situation and other potential participating parties is obtained from a first party over the network. Next, the potential participating parties are notified of an existence of a session and of an opportunity to enter an appearance in the session. Position data from each party that has entered an appearance is obtained and stored. A party that has entered an appearance is allowed to define an issue having a scope, the issue pertaining to the situation, by a process including a succession of at least one step, wherein at each successive step position data defining the scope of the issue is obtained from the party by providing a new template which leads toward narrowing the scope of the issue.

In yet another alternative embodiment, a method for facilitating a finalized agreement pertaining to a situation in a computer negotiation system, wherein multiple issues have been resolved producing multiple agreements during a negotiation session among a plurality of parties is disclosed. First, the multiple agreements are presented to each of the parties in the form of a total agreement. Next, each of the parties is allowed to make suggestions for improvements to the total agreement by engaging in inter-issue bargaining. The suggestions are merged presented to each of the parties forming a finalized agreement.

In yet another alternative embodiment, a method for facilitating agreement pertaining to a situation over a network among a plurality of parties is disclosed. A computerized negotiation log is maintained, the negotiation log being representative of all communications occurring within a structured computerized negotiation session. If the structured negotiation session does not produce an agreement, a human mediator is provided with a transcript representative of the negotiation log of the structured computerized negotiation session for use within a mediation session. A computerized mediation log is maintained, the mediation log being representative of all communications occurring within the mediation session. If the mediation session does not produce an agreement, an arbiter is provided with a transcript representative of the computerized mediation log for use within an arbitration session. In a related embodiment, the method may also include the step of receiving position data from each of the plurality of parties from the network. A set of resolutions, the set having at least one member, is retrieved from a database containing resolutions and associated statistical data. The set of resolutions is based upon the combined position data presented by the plurality of parties. The retrieved set of resolutions is sent to each of the plurality of parties.

In yet another related embodiment, a method for facilitating agreement pertaining to a situation over a network among a plurality of parties in a session is disclosed. First, position data is received over the network, the position data being representative of a position with respect to one or more issues pertinent to a situation. The position data is received from each of the plurality of parties from the network and stored in a computer readable medium. A plurality of methods of achieving a resolution of the respective positions of each of the plurality of parties is provided. In a related embodiment, each of the plurality of methods of achieving a resolution is applied in a resolution sequence until an agreement is produced. In a further related embodiment, the session is monitored, and the parties are provided with an option to discontinue the session prior to achievement of a resolution. The parties may also be allowed an option to alter the resolution sequence. The resolution sequence may proceed from negotiation, mediation, and arbitration. In a related embodiment, a computerized transcript representative of all communications to or from each of the parties occurring within the session is maintained. The computerized transcript may be provided to a computerized negotiation stage, to a human mediator for use during a mediation stage, or to an arbiter for use during an arbitration stage.

### Brief Description of Drawings

The foregoing features of the invention will be more readily understood by reference to the following detailed description, taken with reference to the accompanying drawings, in which:

Fig. 1a is a block diagram showing an exemplary system for facilitating agreement over a network.

Fig. 1b is a block diagram showing an alternative embodiment of the system of Fig. 1a.

Fig. 2 is a flow chart of an embodiment of a method in accordance with the present invention.

Fig. 3 is a flow chart of an embodiment of the Negotiation Initialization process 300 of Fig. 2.

Fig. 4 is a flow chart of an embodiment of the Issue Definition and Clarification process 400 of Fig. 2.

Fig. 5a is a flow chart of an embodiment of the Issue Resolution using a Zone of Possible Agreements process 500 of Fig. 2.

Fig. 5b is a more detailed flow chart of one of the elements of Figure 5a showing a preferred embodiment.

Fig. 5c is a more detailed flow chart of one of the elements of Figure 5a.

Fig. 5d is a more detailed flow chart of one of the elements of Figure 5a.

Fig. 6 is a flow chart of an embodiment of the Post-Negotiation process 600 of Fig. 2.

Figs. 7a and 7b are examples of screens that would be presented in accordance with Step 300 of Fig. 2.

Fig. 8a is a flow chart of an alternate embodiment of a method in accordance with the present invention using a three-tiered approach to facilitating agreement using methods of dispute resolution.

Fig. 8b is a more detailed flow chart of the embodiment shown in Fig. 8a.

Fig. 8c is a flow chart of an alternate embodiment of the method shown in Figs. 8a and 8b.

Fig. 9 is a flow chart of an alternate embodiment of a method in accordance with the present invention.

Fig. 10 is a flow chart of an embodiment of the Negotiation Initialization process 1000 of Fig. 9.

Fig. 11 is a flow chart of an embodiment of the Issue Definition process 1100 of Fig. 9.

Fig. 12a is a flow chart of an embodiment of the Issue Resolution process 1200 of Fig. 9.

Fig. 12b is a more detailed flow chart of process 1210 of Fig. 12a.

Fig. 12c is a more detailed flow chart of process 1230 of Fig. 12a.

Fig. 12d is a more detailed flow chart of a process 1250 of Fig. 12a.

Fig. 12e is a flow chart of an alternate embodiment of the Issue Resolution process 1200 of Fig. 9.

Fig. 13 is a flow chart of an embodiment of the Post-Negotiation process 1300 of Fig. 9.

Fig. 14a is a block diagram showing a conceptual overview of the Negotiation Log and Mediation Log.

Fig. 14b is a block diagram showing an exemplary system for facilitating agreement over a network using a Negotiation Log and a Mediation Log.

### Detailed Description

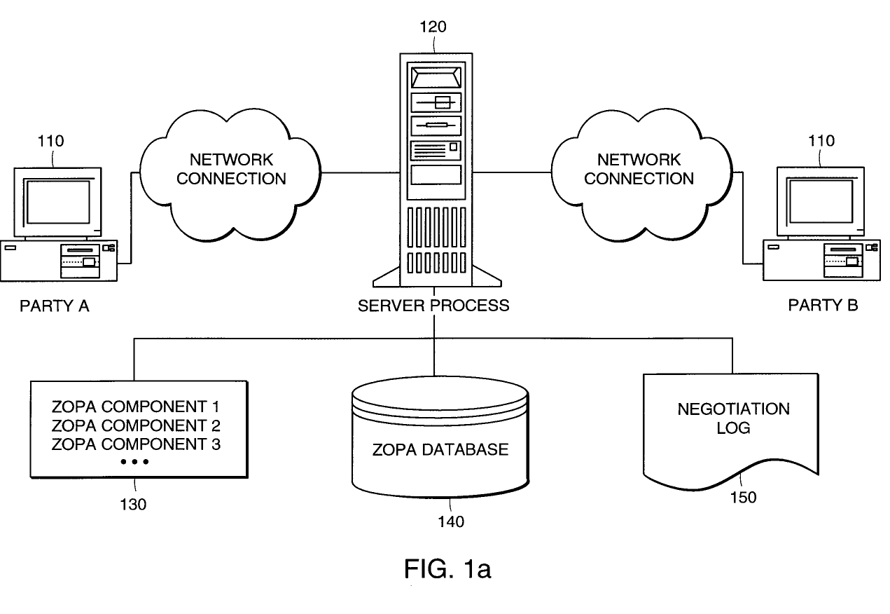

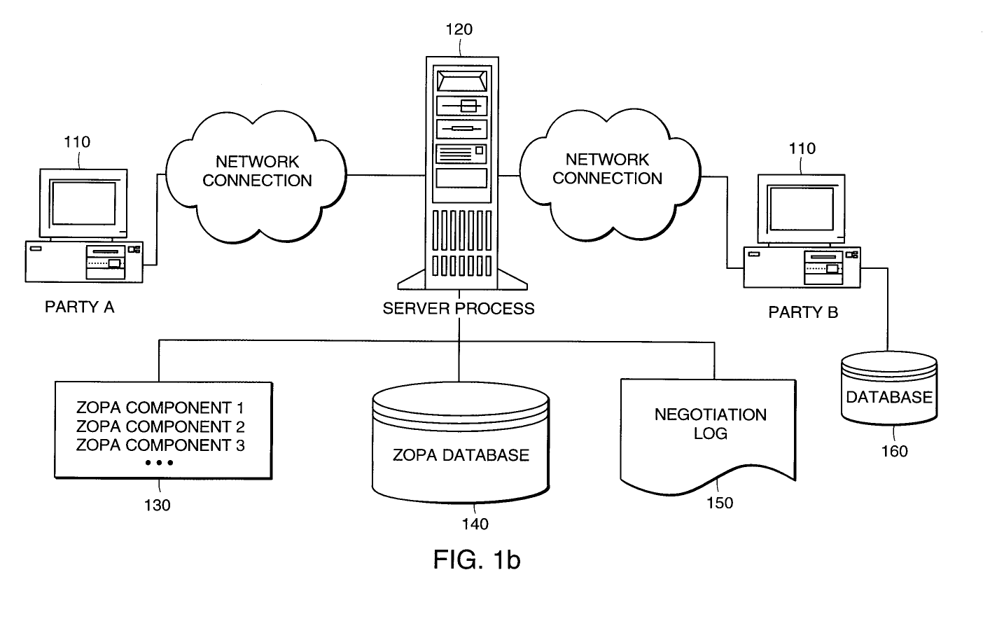

The embodiment of Fig. 1a illustrates a method of facilitating agreement over a network among a plurality of participants. The agreement being sought pertains to what is referred to as a "situation." A "situation" may be a dispute between a customer and a merchant, or a "situation" may be the negotiation of an agreement. The terms "transaction", "situation" and "dispute" will be used interchangeably herein. In the resolution of the situation multiple issues may be presented. While we refer to a "network," it will be understood to include the Internet as well as other networks, including local area networks and wide area networks. The term "template" as used in the following description and appended claims shall mean a graphical user interface for display on a computer for the entry of information or the selection of one or more listed choices.

In one embodiment, for example, as described in further detail below, a series of remote computer terminals may be in communication over a network with a server. In a further embodiment, the server may generate hypertext markup language (HTML) encoded pages to be displayed on the screens of the terminals, and appropriate HTML encoded pages may be used for supplying pertinent data to the server. Thus embodiments of the invention may be implemented over the World Wide Web.

In one potential application, for example, a customer may have a dispute with a merchant. The dispute may arise in connection with a transaction occurring over the Internet or the dispute may involve a transaction that occurred under other circumstances. A dispute may also arise in connection with multiple transactions related to one customer or one customer account. For example, a customer with a credit card account may dispute one or more items appearing on a credit card statement, each item corresponding to a purchase transaction. The customer may contact the issuer of the credit card to resolve such a dispute.

In another potential application, for example, two parties may seek a resolution to a situation prior to the occurrence of a transaction. In this context, the parties may seek to negotiate an agreement. In such a case, the terms of the transaction may be contained in an agreement reached by the two parties. For example, a customer may desire to purchase a vacation package. The vacation package may include many details relating to issues such as itinerary, methods of transportation to each destination, hotel accommodations, meal arrangements, and the like. A vendor of vacation packages may sell preset vacation packages with preset terms including a preset itinerary and other arrangements. However, the vendor may be able to sell more vacation packages by offering customized vacation packages, since many customers may have individual preferences that differ from the terms of the preset vacation package. The customer may wish to customize a preset vacation package by suggesting alterations to some of the preset terms. The vendor may not agree to all of the suggested alterations, but may be willing to customize the vacation package subject to various limitations. In such a case, the customer may contact the vendor in order to reach an agreement regarding the terms of the customized vacation package.

Embodiments of the invention, therefore, may be used on the one hand for post-transaction dispute resolution and pre-transaction agreement negotiation on the other hand.

In Fig. 1a, Party A and Party B engage in a negotiation session to resolve a situation. Although Fig. 1a shows only two parties there may be more than two parties engaged in a negotiation session. Each party preferably has a computer 110 and each party's computer 110 is connected to a central server 120 through a network. Party A initiates a negotiation session by connecting with the central server 120 and providing data to the central server 120 concerning the nature of the situation and the identity of Party B. Party B is then contacted by the central server 120 and asked to engage in the negotiation. If Party B accepts, each of Party A and Party B sends position data over the network to the central server 120. The data sent by the parties may include, for example, information defining the situation and desired resolutions, but the data is not limited to these types of information. Multiple issues may be presented by both parties in their position data. Based on the data provided, the server generates data characterizing a zone of possible agreements (ZOPA) 130, and the data is rendered as a set of components in a template. The template is provided to each party and shows the nature of the situation as presented by both parties. The template includes components showing possible resolutions to the positions of the parties. The central server process generates these components by accessing a database 140 stored on a digital storage medium in communication with the server. Thus, even though multiple issues are presented in a situation the server process is capable of generating a ZOPA 130 with one or more components with only one access to the database 140. The database 140 may be implemented, for example, as a relational database. The relational database associates the data from each party to components in the database to form the ZOPA template 130. The relational database contains statistical information concerning acceptable resolutions previously agreed to by other parties involved in a similar situation. Each party may then respond to the central server 120 by providing additional data, which may, for example, be entered via a provided ZOPA template. The central server 120 receives the new data, and based on this data creates a new ZOPA template 130 which narrows the issues of the situation. After an iterative process, a resolution is reached or a negotiation log is finalized for presentation to a mediator.

All data communications between the parties and the central server process, as well as communications between the parties, may be captured and recorded in the negotiation log file 150 by the server 120. The negotiation log 150 is a series of data fields constructed from the parties' answers posed by the server process. In one embodiment the data fields are a collection of structured data forming a database. Various display templates may be created for accessing specific fields and presenting them to the mediator, arbitrator, the parties or a third party. These display templates allow the data fields to be presented using a standard form. Accessing data fields and creating templates is known to those of ordinary skill in the art. The fields in general will be presented in their totality to each requestor, however, the data displayed in the templates may be amended, abbreviated, etc. based upon the requestor. For example expletives and derogatory statements may be removed prior to transmittal to a party. Further, consumer specific information, such as credit card numbers may be absent from a template which is to be viewed by a mediator or third party. The negotiation log is activated during the intake process and it is attached to a system assigned transaction number. The log is updated continually and remains archived and accessible indefinitely.

In another embodiment, one of the parties may be directly connected to the central server process, rather than being connected by a remote network connection. Although the ZOPA database is shown connected directly to the central server process, it should be understood that the ZOPA database may reside on a remote system connected by a network connection.

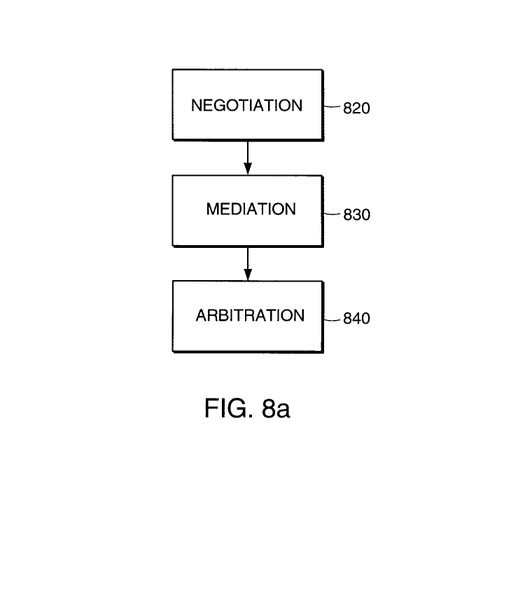

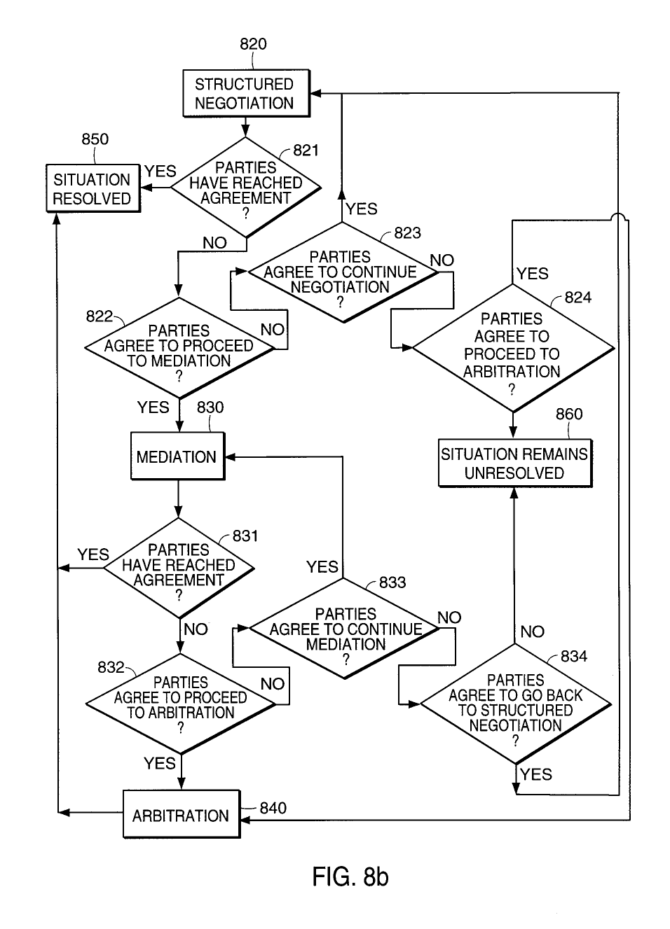

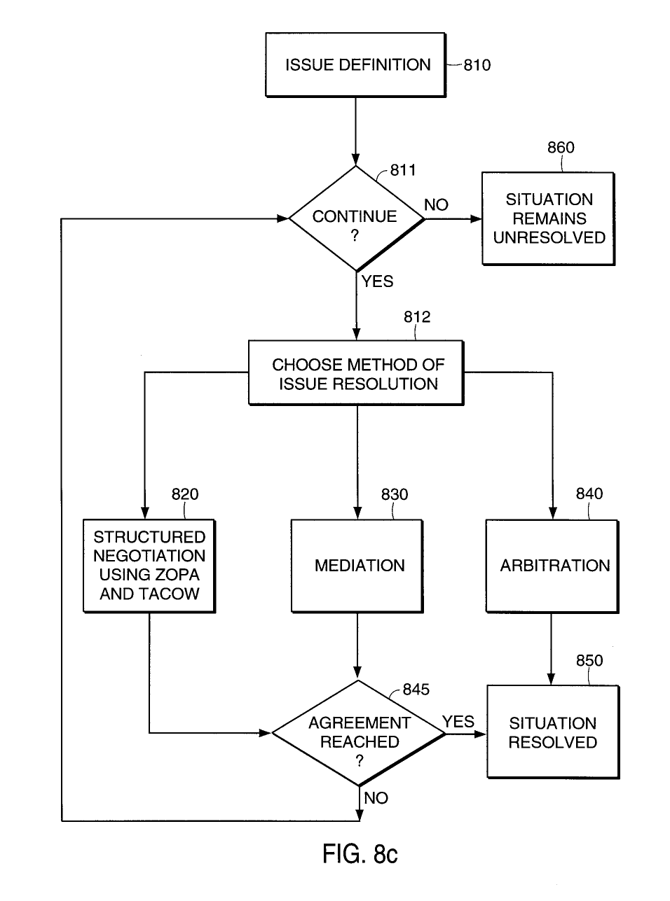

Fig. 1b shows an alternative embodiment in which Party B has an attached database 160. In this embodiment Party B is a merchant that maintains records concerning customers. Data which may be maintained includes the number of transactions that the customer has had with the merchant, the amount of merchandise purchased with the merchant, an associated rating of the customer, and any other data perceived of as pertinent by the merchant concerning the customer. The associated rating of the customer provides a mechanism for the corresponding server process to select the level that the customer should begin resolution. As explained with respect to Fig. 8a there are three possible levels for resolution of the situation. The first being computerized negotiation, the second being mediation, and the third being arbitration. The second and third levels both involve interaction with a live third party for resolving the conflict. If a customer has a high customer rating which indicates the loyalty of the customer as represented by the number, volume, or value of purchases the merchant may wish to bypass the computer negotiation phase and move directly to level two or level three. Additionally, this customer rating may allow the customer with a high rating to select the resolution mechanism. For example, a customer with a high rating which needs resolution of the situation quickly may indicate that mediation or arbitration is the preferred method of resolution. The server process, having the data concerning the customer as provided by the merchant's database, would grant the customer's request based upon the customer rating. The customer rating additionally provides a mechanism for queuing negotiations. For example, if there are multiple situations and only limited resources, for example, the number of mediators and arbitrators or the capacity of the server process, the server process uses the customer rating for adjusting the order for which the situations will be addressed.

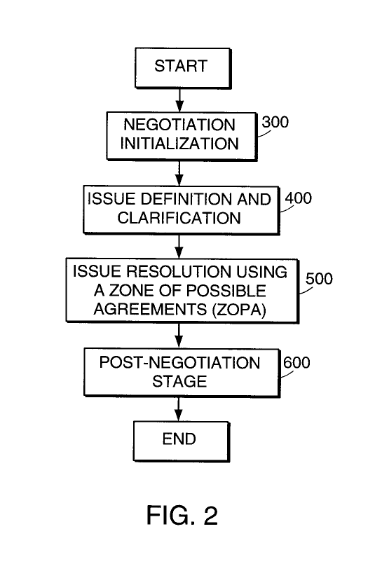

Fig. 2 is a flow chart showing the steps taken by parties in communication with a central processor to begin a negotiation. Step 300 begins the negotiation initialization. This stage might also be called the registration stage, as it includes identification of relevant parties and determination of eligibility to participate. Following the registration stage, the method proceeds to Step 400 which involves issue definition and clarification. At this stage, the parties define the situation in terms of one or more issues. The issues are defined by the server process which first presents a template containing general issues from a database to the parties. Based on the issues selected by the parties the server process selects narrower issues from the database refining the original issues to more specific issues. The issues are also clarified by the parties to ensure that there is agreement regarding which issues must be resolved in order to reach an agreement. Once the situation has been defined by a set of issues, the parties attempt to resolve each separate issue in the set of issues in Step 500. A zone of possible agreements (ZOPA) for an individual issue serves as a guideline for resolution of that issue. The ZOPA comprises a set of possible resolutions to an issue, each of which may be called a ZOPA component. Each ZOPA component is a general resolution of an issue, which may be further refined by the parties to include details specific to the situation. Resolution of an individual issue results in a tentative agreement contingent on the whole (TACOW). The TACOWs are refined and combined into a total agreement at the Post-Negotiation process 600.

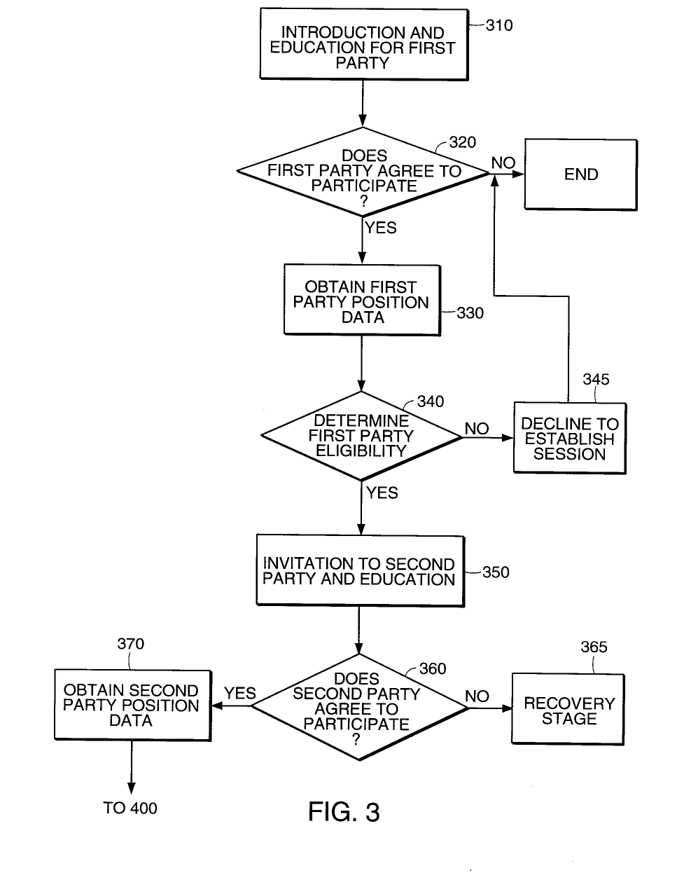

Referring now to Fig. 3, negotiation initialization begins with Step 310 with a first party being introduced to the system and educated about the use of the system. Introduction and education may, for example, be achieved by displaying one or more screens to the first party. In Step 320, the first party may choose whether or not to participate in a negotiation session. For example, a screen providing the terms of use may be displayed to the first party. If the first party does not agree to the terms of use, the process ends. If the first party agrees to the terms of use, the method proceeds to Step 330 and the first party's position data is obtained. Position data obtained from the first party may, for example, include the first party's identity (name, address, phone # etc.), the identity of a second party with whom a dispute exists, and the date of the dispute, but is not limited to such data. The first party may complete a template that will provide structure to the data supplied by the first party, so that the data may be usefully managed in accordance with the method of the embodiment. The next step is to determine whether the first party is eligible, in accordance with a set of criteria, to appear in a session with respect to the situation, as shown in Step 340. Eligibility will necessarily depend on the context of use of the method of this embodiment. For example, if the method is used for dispute resolution in connection with goods sold by a merchant over the Internet, and the first party has indicated that his dispute is unrelated to a transaction with the merchant, the criteria used in this determination will usefully be structured to render the first party ineligible to appear in the session. Similarly, it may be that the first party has a dispute that arose in connection with such a transaction, but the dispute is not really brought in good faith. For example, a party claims that a product does not perform a task even though the product was never intended for that task. In the event of a negative determination, the result is that a session is not established on the basis of the first party's Position data, and the implicit request to establish the session is declined in Step 345. If there is a determination of eligibility in Step 340, then in accordance with Step 350, a second party is invited to participate in the negotiation. In a preferred embodiment, a Negotiation Log file is created which records the position data obtained from the first party. It should be understood that the Negotiation Log file may be created at any other time following the first party's introduction to the system. In some embodiments, the Negotiation Log file may be provided to a human mediator or arbiter should the parties require live negotiation or arbitration. The second party is provided with the first party's position data which briefly outlines the situation that will be the subject of the negotiation session. The second party is also educated in a method similar to Step 310. At Step 360, the second party decides whether or not to participate as in Step 320. For example, if the second party agrees to the terms of use, the method proceeds to Step 370 and the second party's position data may be obtained in a method similar to the method of Step 330. The second party's position data is then recorded and added to the Negotiation Log file. If the second party does not agree to participate, the second party's non-agreement is recorded in the Negotiation Log file, and at Step 365 the second party enters into a first recovery stage. The first recovery stage is designed to persuade the second party to participate in a negotiation session.

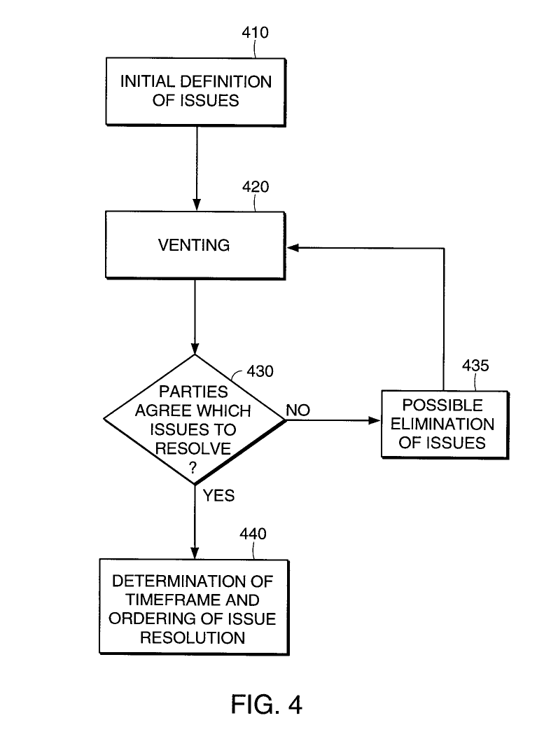

Referring now to Fig. 4, the first party specifies issues which define a situation in Step 410. The first party completes one or more templates to define the issues. In a preferred embodiment, the issues defined by the first party are captured and recorded to the Negotiation Log file. The issues defined by the first party are presented to the second party (for example, by displaying a message on the second party's screen). The second party then has the opportunity to add issues which further define the situation by completing one or more templates. The additional issues defined by the second party may be captured and recorded to the Negotiation Log file. In a preferred embodiment, Step 410 further includes refinement of the issues. It should be understood by one of ordinary skill in the art that each template that is presented to a party is provided by the server process after accessing fields in a database based upon the parties= previous template selections. In accordance with a preferred embodiment, refinement of an issue is achieved by completing one or more templates in a series. Each successive template narrows the scope of the issue. The result of the issue refinement is a set of criteria which will be used to determine the zone of possible agreements (ZOPA) in step 500 of Fig. 2. It should be clear that the results of the issue refinement stage provide the input for the server process to access the ZOPA database and retrieve the ZOPA components. The server process creates a template for the parties based upon the results from the search in the ZOPA database. This set of criteria shall be referred to as the ZOPA criteria set (ZCS). In one embodiment, the first party may also specify a personal resolution for each issue at this time. The personal resolution reflects the first party's interests with respect to resolution of that issue. For example, a party may indicate that a particular issue is more important for overall resolution than another issue. Referring again to Fig. 4, each party independently has the opportunity to vent and to clarify the issues at Step 420. Venting and clarification by a party may involve a text-based approach. The output of one party's venting and clarifying is transmitted to the other party, and in some embodiments, may also be captured and recorded to the Negotiation Log file. The purpose of venting and clarifying is to allow each party to justify including or excluding an issue from the situation. It also presents the parties with an opportunity to describe the situation as they believed it to be in order to identify any miscommunication that may have occurred. In Step 430, if the parties do not agree which issues define the situation, they may eliminate issues as shown by Step 435. Elimination of an issue may be followed by more venting and clarifying. It should be clear that the parties to the situation are in communication with one another through the network via the server process as shown with respect to Fig. 1a.

In one embodiment, each party may have two separate opportunities to vent and to clarify the issues. If, at the end of such venting the parties are still not in agreement over which issues define the situation, the system treats the situation as though the parties are in agreement and proceeds to Step 440. In such a case, the set of issues which defines the situation includes all mutually-agreed upon issues as well as those issues which at least one party has included and which has not been eliminated. At Step 440, an issue resolution time line is determined by the parties. Since the issues will be resolved individually during the course of a negotiation session, the issues must be addressed according to some chronology determined by the parties. The issue resolution time line therefore includes an ordinal ranking of the individual issues as well as an absolute time frame for the negotiation session. In a preferred embodiment, a proposed issue resolution time line is presented to the parties. If the parties agree on such a time line, the method proceeds to Step 500 of Fig. 2. If the parties do not agree on the proposed time line, the first party may present an alternate proposed time line to the second party. The second party may review the alternate proposed time line and accept it, or the second party may present yet another alternate proposed time line. Each party may have, for example, two opportunities to make a proposal before the method assigns an issue resolution time line to the negotiation session.

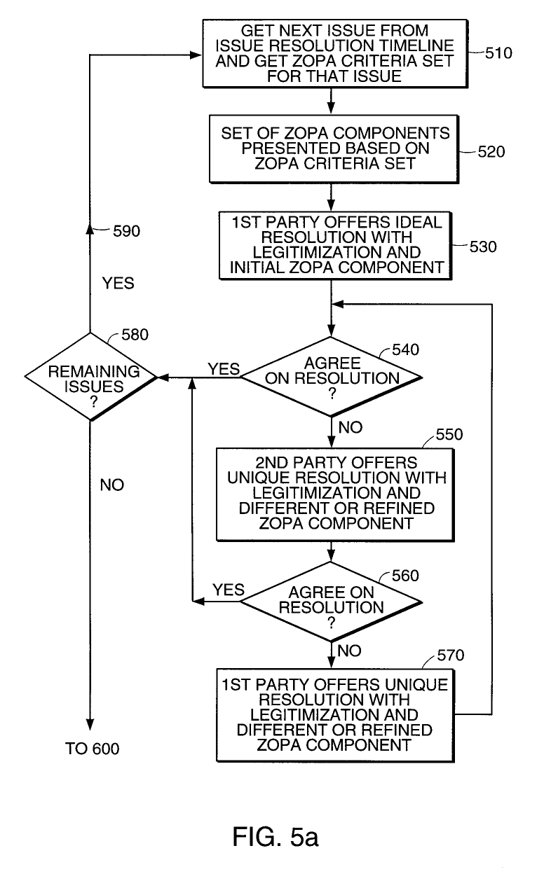

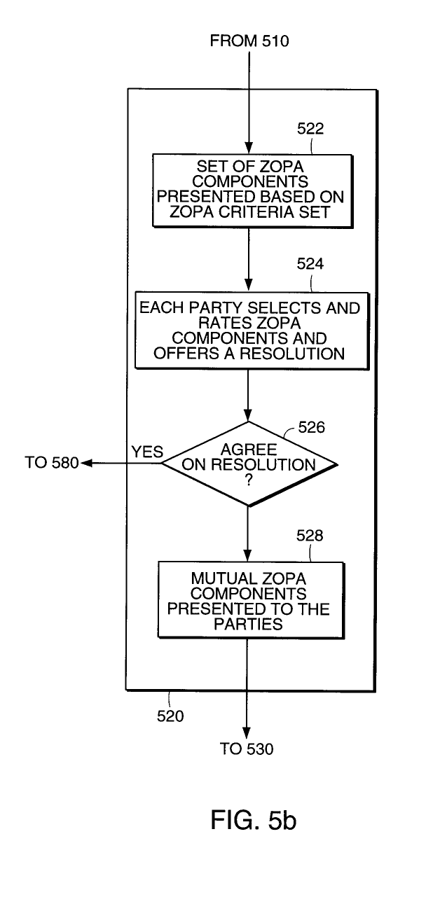

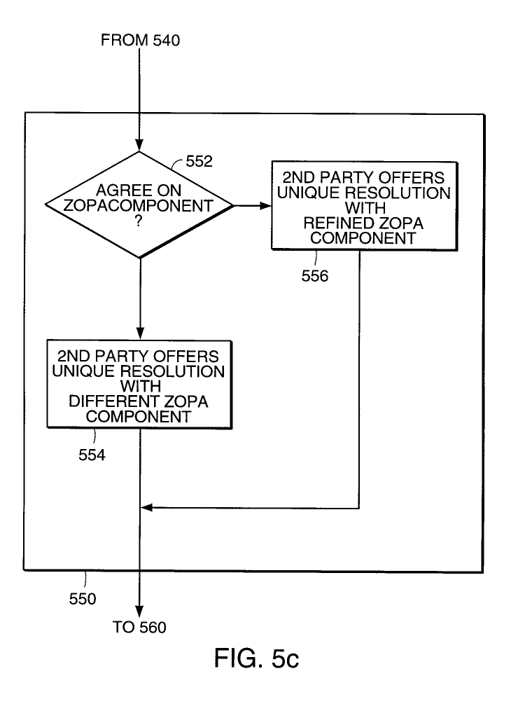

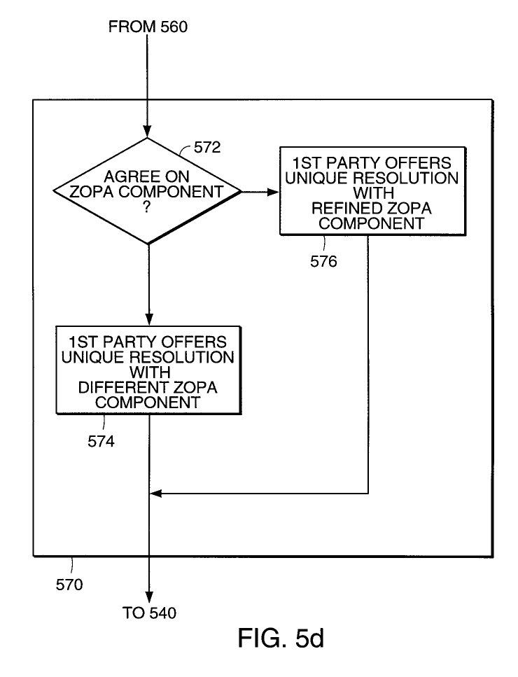

Referring now to Fig. 5a, at Step 510, an issue to be resolved is taken from the issue resolution time line, and the ZOPA criteria set (ZCS) for that issue is retrieved. A zone of possible agreements (ZOPA) will be determined based on the ZCS. A ZOPA is simply a set of possible resolutions to an issue. In Step 520, a set of ZOPA components is presented to the parties. A ZOPA component is simply a single resolution to the issue within the ZOPA. In a preferred embodiment shown in Figure 5b, a set of ZOPA components is presented to the parties in Step 522. In Step 524, each party selects and rates ZOPA components and offers a resolution. If the parties agree on the resolution at Step 526, the method proceeds to Step 580. If the parties do not agree on the resolution, the parties are presented in Step 528 with a list of ZOPA components mutually chosen by the parties, according to the ratings given by the parties. In an alternate embodiment, Step 520 does not involve the parties independently choosing ZOPA components and rating them. In another embodiment of the invention, when the various ZOPA components are presented the server process includes statistical data from previous negotiations having similar issues. For instance, if the dispute is over the quantity of goods shipped one resolution might be "Send additional goods. (87%)." The 87% would represent the percentage of parties that had accepted this ZOPA component. Providing the statistical data assists the parties in determining whether to accept the ZOPA component by providing insight into how other similar negotiations were resolved.

Referring again to Fig. 5a, the first party offers an ideal resolution with legitimization and an initial ZOPA component in Step 530. The first party may select one of the ZOPA components as an ideal resolution or may choose a unique resolution. The offered resolution must be legitimized. The first party legitimizes the offered resolution by giving reasons supporting the offered resolution. If the offered resolution is a ZOPA component, then legitimization could be based on the fact that the chosen ZOPA component has been previously used as a resolution in a situation involving the same set of ZOPA criteria. If the offered resolution is not one of the ZOPA components but is a unique resolution, legitimization could be based on another type of reason offered by the first party (i.e. "None of the ZOPA components in the suggested ZOPA is an acceptable resolution."). In this case, the first party must also offer an alternative resolution which must be a ZOPA component from the suggested ZOPA. This ensures that at least one ZOPA component is selected by the first party. The first party's resolution with legitimization and initial ZOPA component is transmitted to the second party. If the parties agree on the resolution in Step 540, then the individual issue is resolved. If there are remaining issues in Step 580, then the next issue to be resolved is handled in Step 590 and the process loops back to Step 510. If there are no remaining issues in Step 580 then the method proceeds to Step 600 of Fig. 2. If the parties do not agree on the resolution in Step 540, then the second party offers a unique resolution with legitimization and a different or refined ZOPA component in Step 550. Referring now to Fig. 5c, the second party chooses a refined or a different ZOPA component based on the result of Step 552. If the second party agrees with the ZOPA component offered by the first party, that particular ZOPA component may be refined in Step 556. The purpose of refinement is to more specifically define a particular ZOPA component. For example, if the ZOPA component is "Apology," then possible refined ZOPA components might include "Written Apology" and "Written Apology with Gift Certificate." Refinements could be automatically suggested or the parties could suggest refinements. If, at Step 552, the second party does not agree with the ZOPA component offered by the first party, then the second party chooses a different ZOPA component in Step 554. The second party's unique resolution with legitimization and new (refined or different) ZOPA component is transmitted to the first party. Referring again to Fig. 5a, if the parties agree on the new resolution in Step 560, the method proceeds to Step 580. If the parties do not agree on the resolution, the method proceeds to Step 570, which is shown in more detail in Fig. 5d. Referring now to Fig. 5d, the method proceeds in a manner similar to the method shown in Fig. 5c, except that the first party is involved rather than the second party. Referring again to Fig. 5a, the method proceeds from Step 570 and loops back to Step 540.

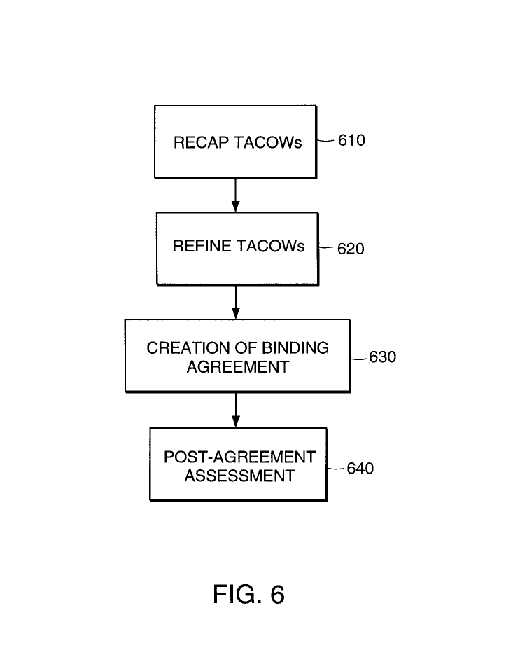

Referring now to Fig. 6, the Post-Negotiation process begins at Step 610 with a recap of the mutually agreed upon resolutions to the individual issues. A resolution to an individual issue is referred to as a tentative agreement contingent on the whole (TACOW). The combination of the TACOWs comprise a total resolution or a TACOW set. In many conventional negotiations involving multiple issues, the parties may engage in what might be called inter-issue bargaining. Inter-issue bargaining involves a first party making concessions on a first issue in exchange for the second party making concessions on a second issue. Because the issues are resolved separately and individually in Step 500, the initial TACOW set at Step 610 does not reflect the results of any inter-issue bargaining. At Step 620, the parties engage in inter-issue bargaining to refine the TACOWs. Once the TACOWs have been refined into a total agreement, the total agreement is incorporated into a binding agreement at Step 630. In a preferred embodiment, this step further includes generation of a written contract of which the parties can print copies. Following this step, the parties evaluate their experience in Step 640. The parties may evaluate their experiences, for example, in terms of their satisfaction with the process and the resolution. This data is then captured and recorded to the ZOPA database.

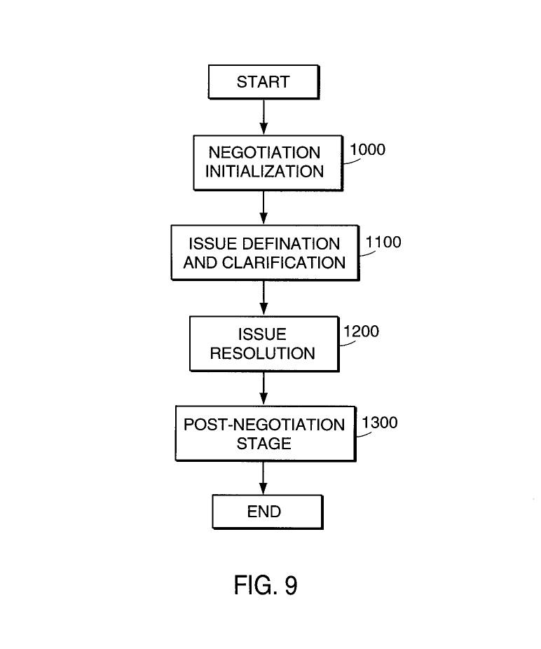

Referring now to Fig. 9, an alternate embodiment of a method in accordance with the present invention is shown. The method described may be particularly suited, for example, to resolution of a post-transaction dispute between a consumer and a merchant. This is because the method does not require obtaining the second party's consent to participate in the process, as it may be implicitly determined if, for example, the second party is a merchant who has previously agreed to participate in sessions to resolve post-transaction disputes. Furthermore, many post-transaction disputes are similar in nature so that statistical data pertaining to previous resolutions to a similar situation may be particularly useful in aiding in the resolution of the present situation. In Fig. 9, the processes 1000, 1100, 1200, and 1300 roughly correspond to the processes 300, 400, 500, and 600 of Fig. 2.

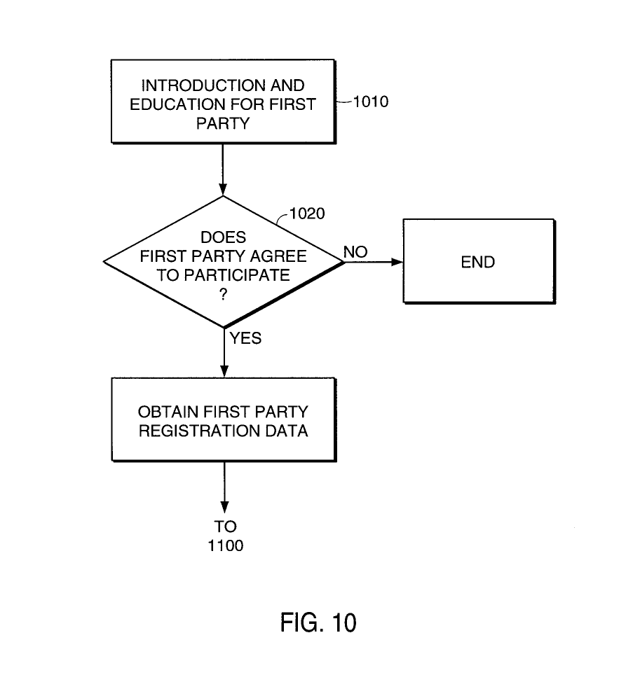

In Fig. 10, the Negotiation Initialization process begins with and introduction and education in Step 1010. Introduction and education may, for example, be achieved by presenting a series of HTML-encoded web pages to a first party accessing a website. Terms and conditions of use may be supplied to the first party during this process. If the first party indicates agreement to the terms and conditions in Step 1020, for example, by clicking on a button marked "I Agree," the method proceeds to Step 1030, at which point registration data may be obtained from the first party. Registration data may include, for example, identification information such as name, address, telephone number, e-mail address, a password, and the like.

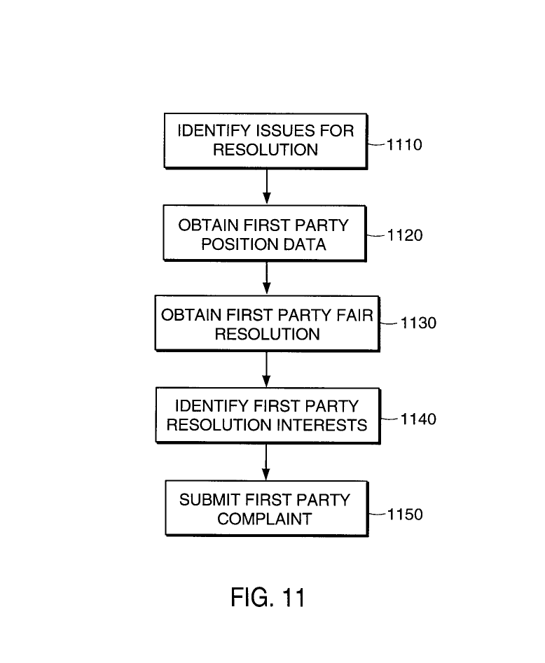

Referring now to Fig. 11, the first party specifies issues which define a situation in Step 1110. The first party may completes one or more templates to define the issues. In a preferred embodiment, the issues defined by the first party are captured and recorded to the Negotiation Log file. In a preferred embodiment, Step 1110 further includes refinement of the issues. In accordance with a preferred embodiment, refinement of an issue is achieved by completing one or more templates in a series. Each successive template narrows the scope of the issue. The result of the issue refinement is a set of criteria which will be used to determine the zone of possible agreements (ZOPA) in step 1200 of Fig. 9. This set of criteria shall be referred to as the ZOPA criteria set (ZCS). In Step 1120, the first party supplies position data with respect to the issues identified in Step 1110. Position data is representative of the first party's position regarding the circumstances which create the need for a resolution of the issues. For example, the first party may have ordered 100 widgets from Company A. One of the issues identified may be "Price." The position data with respect to this issue may be, for example, "The agreed upon price was to include shipping costs, but the invoice did not reflect this agreement." In Step 1130, the first party may propose a fair resolution for each issue at this time. The set of proposed fair resolutions constitutes the first party's desired resolution set. Each proposed fair resolution in the desired resolution set reflects the first party's interests with respect to resolution of that issue. The first party identifies which interests should be addressed by each resolution in Step 1140.

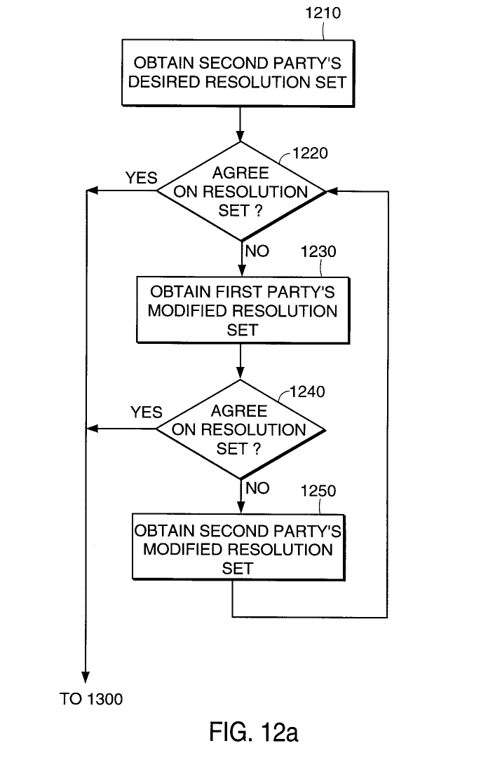

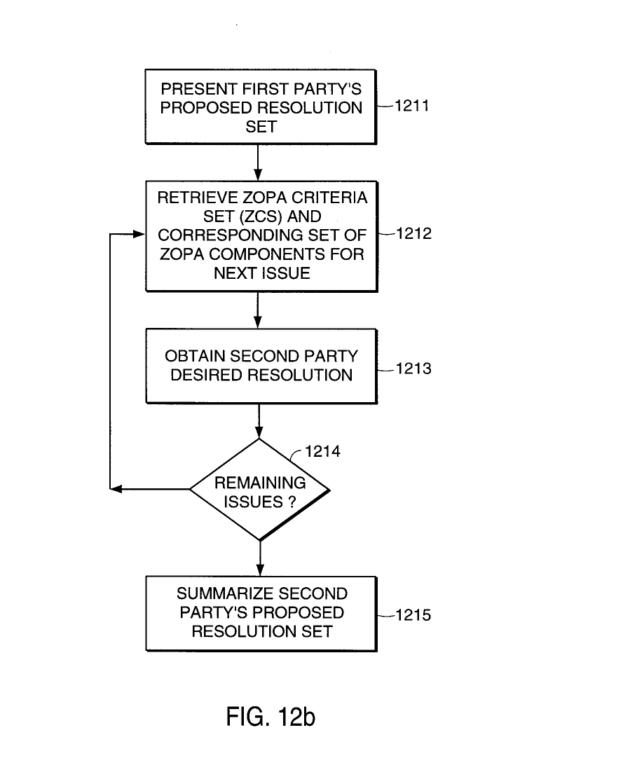

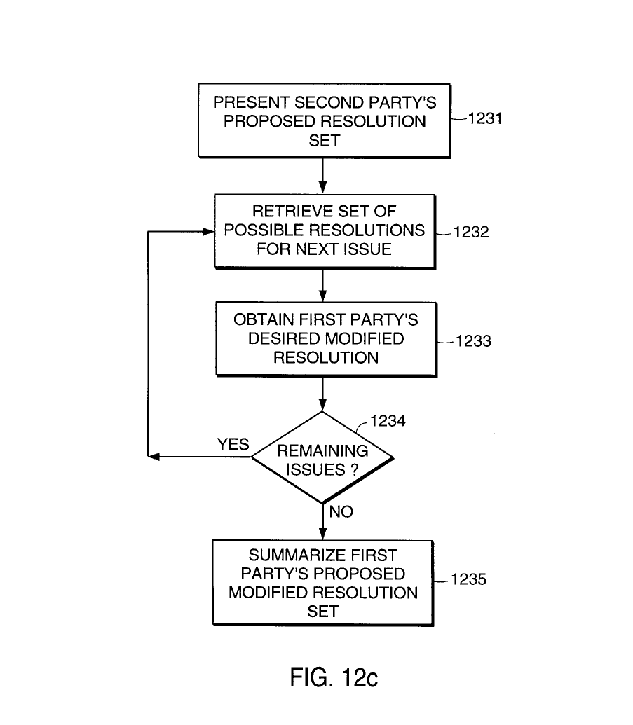

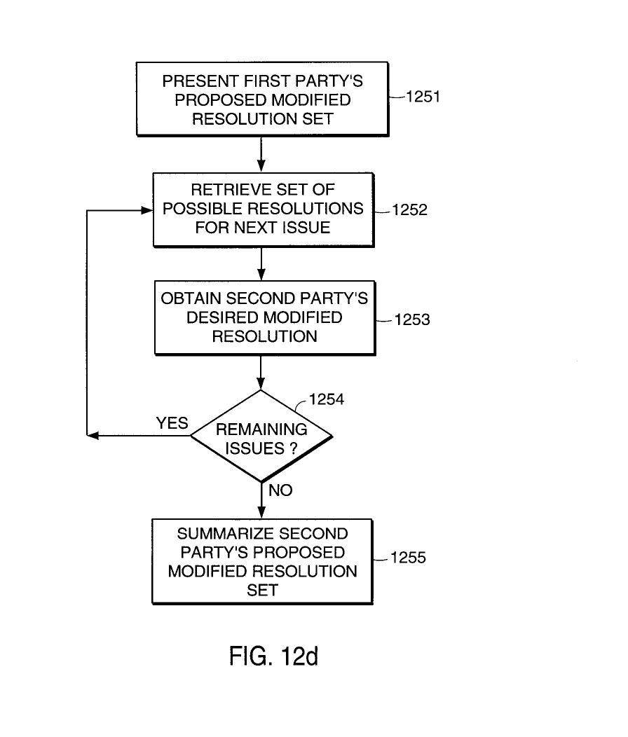

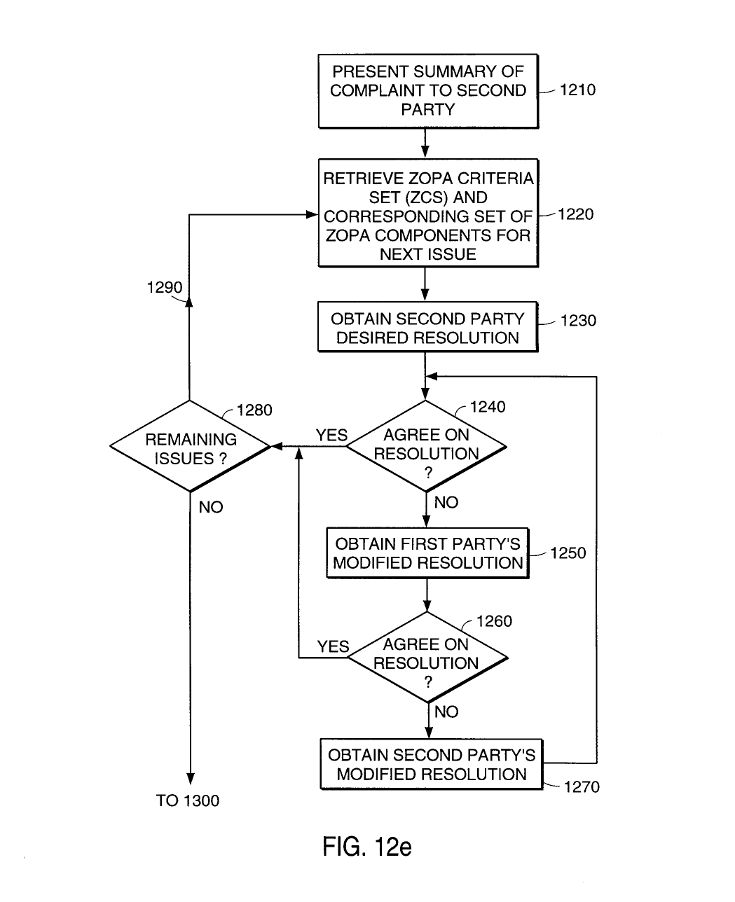

Referring now to Fig. 12a, the second party's desired resolution set is obtained in Step 1210. Fig. 12b shows a more detailed flow chart of Step 1210. With reference now to Fig. 12b, the first party's proposed resolution set is presented in Step 1211. In Step 1212, a set of ZOPA components is retrieved for each issue. The second party may select a desired resolution in Step 1213 from the set of ZOPA components, or may choose the first party's proposed resolution. If there are remaining issues in Step 1214 the process loops back to Step 1212. In Step 1215, the second party's desired resolutions are summarized in a proposed resolution set.

Referring again to Fig. 12a, the first party's proposed resolution set and the second party's proposed resolution set are compared in Step 1220. If the two parties have agreed on a resolution set, the method proceeds to Step 1300. Otherwise, the first party supplies a modified resolution set in Step 1230. Fig. 12c shows a more detailed flow chart of Step 1230. With reference now to Fig. 12c, the second party's proposed resolution set is presented in Step 1231. In Step 1232, a set of possible resolutions is retrieved for each issue. The set of possible resolutions may include, for example, ZOPA components retrieved in Step 1212 of Fig. 12b as well as the second party's proposed resolution obtained in Step 1213 of Fig. 12b. The first party may select a desired resolution in Step 1233 from the this set of possible resolutions or may choose to modify one of these resolutions. Modification of a resolution may be achieved, for example, via completion of a template. If there are remaining issues in Step 1234 the process loops back to Step 1232. In Step 1235, the first party's modified desired resolutions are summarized in a proposed modified resolution set.

Referring again to Fig. 12a, the second party's proposed resolution set and the first party's proposed modified resolution set are compared in Step 1240. If the two parties have agreed on a resolution set, the method proceeds to Step 1300. Otherwise, the second party supplies a modified resolution set in Step 1250. Fig. 12d shows a more detailed flow chart of Step 1250. With reference now to Fig. 12d, the first party's proposed modified resolution set is presented in Step 1251. In Step 1252, a set possible resolutions is retrieved for each issue. The set of possible resolutions may include, for example, ZOPA components retrieved in step 1212 of Fig. 12b as well as the first party's proposed modified resolution. The second party may select a desired resolution in Step 1253 from the this set of possible resolutions or may choose to modify one of these resolutions. Modification of a resolution may be achieved, for example, via completion of a template. If there are remaining issues in Step 1254 the process loops back to Step 1252. In Step 1255, the first party's modified desired resolutions are summarized in a proposed modified resolution set.

Fig. 12e shows a flow chart of an alternate embodiment of a method of the present invention. Resolution of one issue is achieved before the next issue is processed. Resolution of individual issues follows the same process as is shown in Fig. 12a.

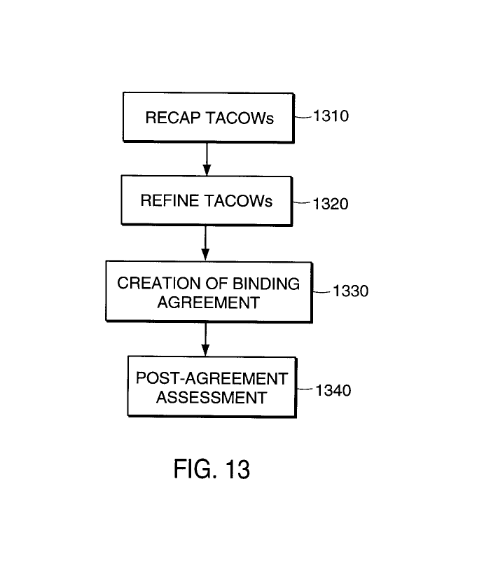

Referring now to Fig. 13, a flow chart of the Post-Negotiation process 1300 of Fig. 9 is shown. Steps 1310, 1320, 1330, and 1340 correspond, respectively, to Steps 610, 620, 630, and 640 of Fig. 6.

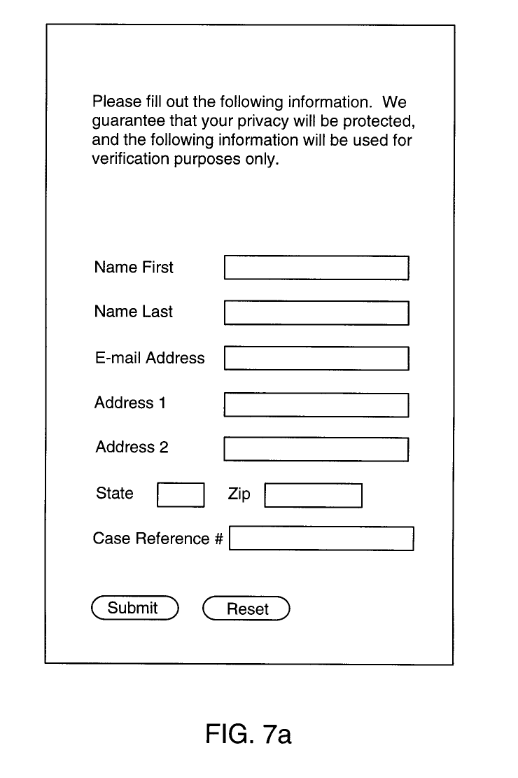

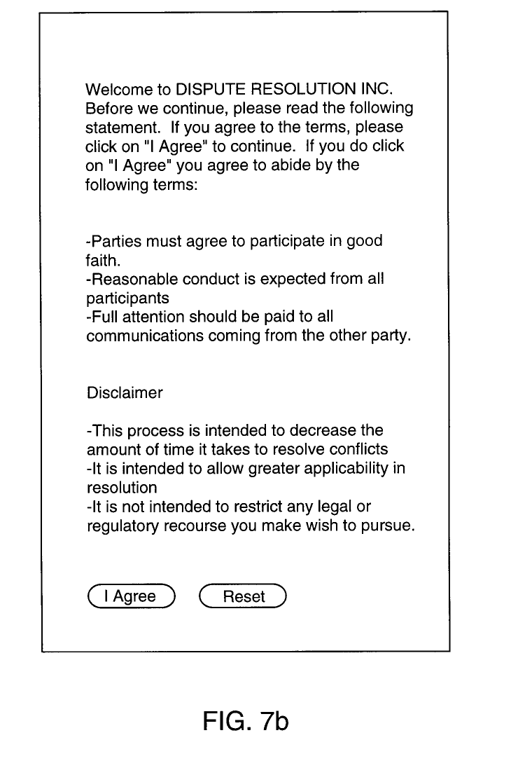

Figs. 7a and 7b show examples of screens presented to a party during Step 300 of Fig. 2 in an embodiment of the present invention. In Fig. 7a a case reference number is requested. If this is not provided by the party entering information a number is generated for the case. This number allows the parties to access case information including the negotiation log throughout the negotiation process. In an alternative embodiment, a pull-down box on the template may be provided with a listing of the possible participating parties, such as, merchants or companies. This allows the customer to know whether the merchant/other party is bound to participate in negotiations or whether the consent of the other party is necessary before negotiations will begin.

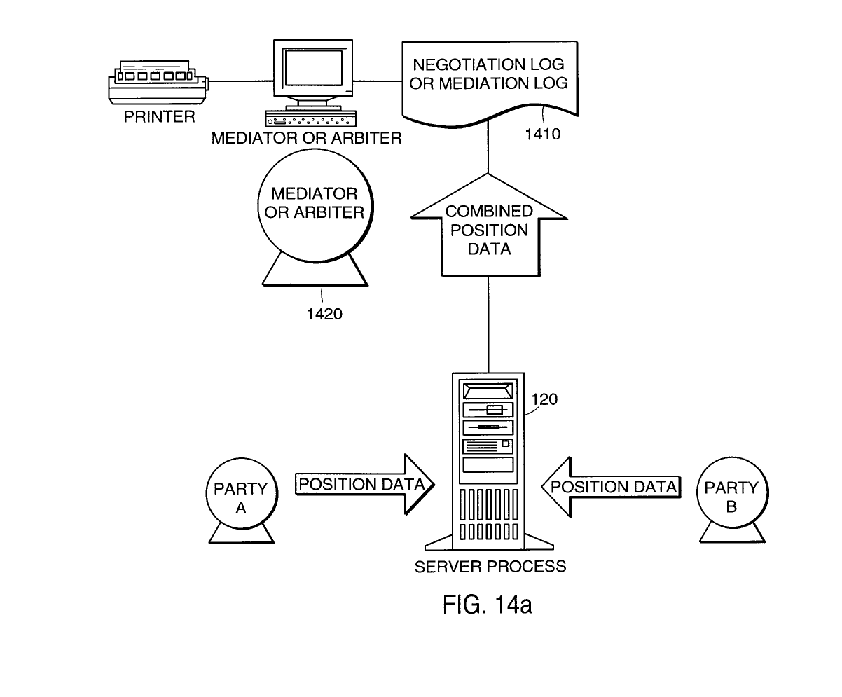

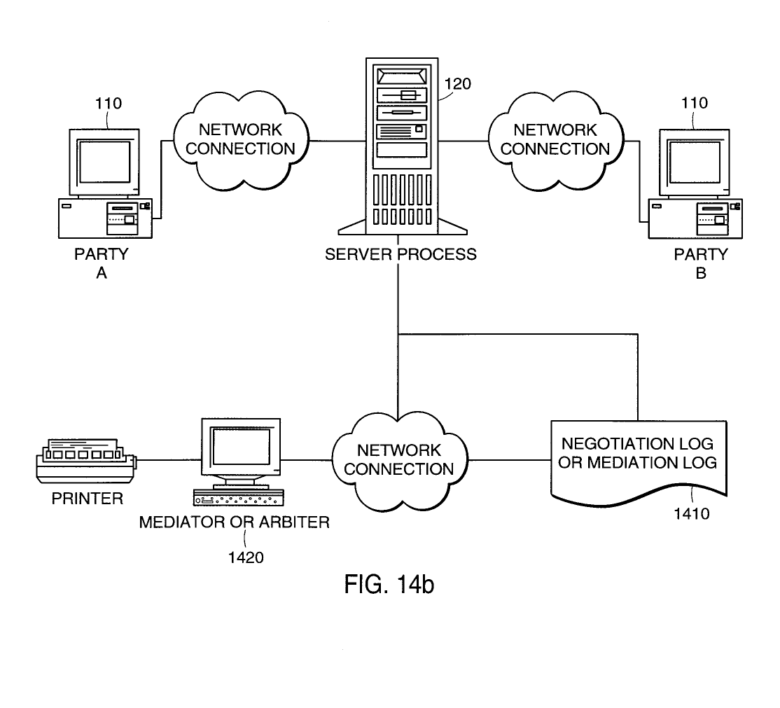

With references to Figs. 8a and 8b, a flow chart is shown of an alternate embodiment of a method of facilitating agreement using a three-tiered approach of alternative dispute resolution (ADR). Methods of ADR include negotiation, mediation, and arbitration. Referring to Fig. 8a, Step 820 is a structured computerized negotiation session stage which comprises the elements of Fig. 2. A computerized Negotiation Log which contains all of the communications occurring within the structured computerized negotiation session is maintained. Fig. 14a shows a conceptual overview of the Negotiation Log. Party A and Party B send position data to the central server process during the structured computerized negotiation session. The combined position data is captured and recorded to a Negotiation Log. If an agreement cannot be reached in Step 820 and the parties agree to mediation, a transcript representative of the computerized Negotiation Log file is forwarded to a live mediator in Step 830 and negotiations continue in a "live" mediation session over the network. The transcript provides a time line of the events and communications that have transpired among the parties. The live mediator preferably has a computer that is connected to the network shown in Fig. 1a. This arrangement is shown in Fig. 14b. The live mediator monitors all communications among the parties, which are also captured and recorded to a computerized Mediation Log file. Fig. 14a shows a conceptual overview of the Mediation Log. Party A and Party B send position data to the central server process during the live mediation session. The combined position data is captured and recorded to a Mediation Log. If mediation is unsuccessful in producing agreement, the parties may proceed to an arbitration session in Step 840. A transcript of the Mediation Log file, which includes a transcript of the Negotiation Log file, is forwarded to an arbiter. In a preferred embodiment, the arbiter has a computer that is connected to the network shown in Figure 1a. This arrangement is shown in Fig. 14b. The arbiter can use the information contained in the transcript of the Mediation Log file to resolve the situation.

Referring now to Fig. 8b, the parties participate in a structured negotiation session in Step 820. At any time prior to reaching an agreement during a structured negotiation session, the parties may opt to stop negotiations, to proceed to mediation, or to proceed to arbitration. These options may also be presented to the parties, for example, at the expiration of a predetermined time limit or at regular time intervals throughout the structured negotiation session. If the parties have reached an agreement at Step 821, then the situation has been resolved. If an agreement has not been reached and the parties do not wish to proceed to mediation at Step 822, a second recovery stage at Step 823 allows the parties to return to structured negotiation. If the parties do not agree to continue negotiations, they are given the option at Step 824 to skip to an arbitration session 840. If the parties do not agree to proceed to arbitration at Step 824, then the situation remains unresolved. If the parties agree to proceed to mediation at Step 822, a transcript representative of the computerized Negotiation Log file is forwarded to a human mediator and a mediation session is begun in Step 830. At any time prior to reaching an agreement during a mediation session, the parties may opt to stop mediation, to proceed to arbitration, or to return to structured negotiation. These options may also be presented to the parties, for example, at the expiration of a predetermined time limit or at regular time intervals throughout the mediation session. If the parties have reached an agreement at Step 831, then the situation has been resolved. If an agreement has not been reached and the parties do not wish to proceed to arbitration at Step 832, a third recovery stage at Step 833 allows the parties to return to mediation. If the parties do not agree to continue mediation, they are given the option at Step 834 to return to a structured negotiation session 820. If the parties do not agree to return to structured negotiation at Step 834, then the situation remains unresolved.

Referring now to Fig. 8c, an alternate embodiment of a method of facilitating agreement using a three-tiered approach of ADR is shown. Step 810 is an issue definition stage which corresponds to Step 400 of Fig. 2. At Step 811, the parties make a decision whether or not to proceed. A method of issue resolution is chosen at Step 812, with three options presented to the parties. A computerized transcript of all communications up to this point is maintained at this stage and passed to either a structured computerized negotiation session in Step 820, to a human mediator in Step 830, or to a human arbiter in Step 840 depending on which method of issue resolution is chosen at this stage. Step 820 is a structured negotiation session using a ZOPA and TACOW approach, which corresponds to Steps 500 and 600 of Fig. 2. Step 830 is a mediation session, and Step 840 is an arbitration session. During either a structured negotiation session 830 or a mediation session 840, a computerized transcript is maintained that is representative of all communications that have occurred and all communications that occur during the session. At any time prior to reaching an agreement in either a structured negotiation session 820 or a mediation session 830, the parties may agree to discontinue the session or to choose another method of issue resolution. At Step 845, if an agreement has been reached, the situation is resolved. Otherwise, the method loops back to Step 811. If at Step 812 the parties agree to an arbitration session 840, the decision is binding and a binding agreement is necessarily produced.

Preferred embodiments of the invention may be implemented as a computer program product for use with a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

Claims

1. A method for facilitating agreement pertaining to a situation over a network among a plurality of parties, the method comprising:
receiving position data from each of the plurality of parties over the network;
storing the position data;
retrieving a set of resolutions, the set having at least one member, from a database containing resolutions, the set of resolutions being based upon the combined position data presented by the plurality of parties; and
sending the retrieved set of resolutions to each of the plurality of parties.

2. A method according to claim 1, wherein the database further includes statistical data associated with resolutions, the statistical data concerning acceptable resolutions previously agreed to by other parties involved in a similar situation, and wherein sending the retrieved set of resolutions further includes sending the associated statistical data.

3. A method according to claim 1, wherein the situation involves a plurality of issues,
each issue requiring a separate resolution, the method further comprising:
sending a plurality of retrieved sets of resolutions to each of the plurality of parties.

4. A method according to claim 3, wherein sending the plurality of retrieved sets of resolutions further includes presenting the plurality of retrieved sets of resolutions to each of the plurality of parties in the form of a plurality of templates.

5. A method according to claim 4, further comprising:
interactively retrieving a plurality of alternative sets of resolutions which are tailored based on additional data provided by at least one of the parties.

6. The method according to claim 5, further comprising:
producing an agreement based upon resolutions agreed to by each of the parties.

7. A method according to claim 1, wherein sending the retrieved set of resolutions further includes presenting the retrieved set of resolutions in the form of a template.

8. A method according to claim 7, the method further comprising:
iteratively retrieving an alternative set of resolutions which is tailored based on additional data provided by at least one of the parties.

9. A computer program product for use on a computer system for facilitating agreement pertaining to a situation over a network, the computer program product comprising a computer usable medium having computer readable program code thereon, the computer readable program code comprising:
computer code for receiving position data from each of the plurality of parties over the network;
computer code for storing the position data;
computer code for retrieving a set of resolutions, the set having at least one member, from a database containing resolutions and associated statistical data, the set of resolutions being based upon the combined position data presented by the plurality of parties; and
computer code for sending the retrieved set of resolutions to each of the plurality of parties.

10. A computer program product according to claim 9, further comprising:
computer code for iteratively retrieving an alternative set of resolutions which is tailored based on additional data provided by at least one of the parties.

11. A computer program product according to claim 10, further comprising:
computer code for producing an agreement based upon resolutions agreed to by each of the parties.

12. A system for negotiating a situation among a plurality of parties connected to a network, the system comprising:
a processor connected to the network for receiving position data, the position data being representative of a position with respect to an issue pertinent to a situation, from each of a plurality of parties; and
digital storage means, in communication with the processor, having a database containing statistical data of possible resolutions which may be accessed by the processor based upon the combined position data presented by the plurality of parties, the storage medium passing the resolutions associated with the statistical data to the processor and the processor sending the resolutions to each of the plurality of parties.

13.The system according to claim 12, further comprising:
a negotiation log composed of multiple fields for storing position data sent by the parties.

14.The system according to claim 12, further comprising:
a plurality of computer nodes coupled to the network for sending data and receiving resolutions from the processor, each computer node being operated by one of the plurality of parties.

15. A data arrangement of computer readable code on a computer readable medium for providing a negotiation history, the data arrangement comprising:
a plurality of fields for use with a database for containing position data, the position data being representative of a position with respect to at least one issue pertinent to a situation, for each of a plurality of parties through stages of a negotiation in a computer-based negotiation process; and
an output template for use with the fields that arranges the fields in chronological order.

16. A method of facilitating agreement, pertaining to a situation over a network among a plurality of parties, the method comprising:
obtaining, over the network, from a first party, first party data identifying the situation and other potential participating parties;
notifying over the network the potential participating parties of an existence of a session and of an opportunity to enter an appearance in the session;
obtaining position data from each party that has entered an appearance and storing such position data; and
allowing a party that has entered an appearance to define an issue having a scope, the issue pertaining to the situation, by a process including a succession of at least one step, wherein at each successive step position data defining the scope of the issue is obtained from the party by providing a new template which leads toward narrowing the scope of the issue.

17. A computer program product for use on a computer system for facilitating agreement pertaining to a situation over a network, the computer program product comprising a computer usable medium having computer readable program code thereon, the computer readable program code comprising:
computer code for obtaining, over the network, from a first party, first party data identifying the situation and other potential participating parties;
computer code for notifying over the network the potential participating parties of an existence of a session and of an opportunity to enter an appearance in the session;
computer code for obtaining position data from each party that has entered an appearance and storing such position data; and
computer code for allowing a party that has entered an appearance to define an issue having a scope, the issue pertaining to the situation, by a process including a succession of one or more steps, wherein at each successive step position data defining the scope of the issue is obtained from the party by providing a new template which leads toward narrowing the scope of the issue.

18. A method for facilitating a finalized agreement pertaining to a situation in a computer negotiation system, wherein multiple issues have been resolved producing multiple agreements during a negotiation session among a plurality of parties, the method comprising:
presenting the multiple agreements to each of the parties in the form of a total agreement;
allowing each of the parties to make suggestions for improvements to the total agreement by engaging in inter-issue bargaining; and
merging the suggestions and presenting the merged suggestions to each of the parties forming a finalized agreement.

19. A computer program product for use on a computer system for facilitating a finalized agreement pertaining to a situation in a computer negotiation system, wherein multiple issues have been resolved producing multiple agreements during a negotiation session among a plurality of parties, the computer program product comprising a computer usable medium having computer readable program code thereon, the computer readable program code comprising:
computer code for presenting the multiple agreements to each of the parties in the form of a total agreement;
computer code for allowing each of the parties to make suggestions for improvements to the total agreement by engaging in inter-issue bargaining; and
computer code for merging the suggestions and presenting the merged suggestions to each of the parties forming a finalized agreement.

20. A method for facilitating agreement pertaining to a situation over a network among a plurality of parties, the method comprising:
maintaining a computerized negotiation log of all communications occurring within a structured computerized negotiation session; and
providing a transcript representative of the negotiation log of the structured computerized negotiation session for use by a human mediator within a mediation session if the structured computerized negotiation session does not produce an agreement.

21. A method according to claim 20, the method further comprising:
maintaining a computerized mediation log of all communications occurring within the mediation session; and
providing a transcript representative of the computerized mediation log for use by an arbiter within an arbitration session if the mediation session does not produce an agreement.

22. A method according to claim 20, the method further comprising:
receiving position data from each of the plurality of parties over the network;
retrieving a set resolutions, the set having at least one member, from a database containing resolutions and associated statistical data, the set of resolutions being based upon the combined position data presented by the plurality of parties; and
sending the retrieved set of resolutions to each of the plurality of parties.

23. A computer program product for use on a computer system for facilitating agreement pertaining to a situation over a network among a plurality of parties, the computer program product comprising a computer usable medium having computer readable program code thereon, the computer readable code comprising:
computer code for maintaining a computerized negotiation log of all communications occurring within a structured computerized negotiation session; and
computer code for providing a transcript representative of the negotiation log for use by a human mediator within a mediation session if the structured computerized negotiation session does not produce an agreement.

24. A computer program product according to claim 23, further comprising:
computer code for maintaining a computerized mediation log of all communications occurring within the mediation session; and
computer code for providing a transcript representative of mediation log for use by an arbiter within an arbitration session if the mediation session does not produce an agreement.

25. A method for facilitating agreement pertaining to a situation over a network among a plurality of parties in a session, the method comprising:
receiving over the network position data, the position data being representative of a position with respect to one or more issues pertinent to a situation, from each of the plurality of parties from the network and storing it in a computer readable medium; and
providing a plurality of methods of achieving a resolution of the respective positions of each of the plurality of parties.

26. A method according to claim 25, the method further comprising:
applying each of the plurality of methods of achieving a resolution in a resolution sequence until an agreement is produced.

27. A method according to claim 26, the method further comprising:
monitoring the session and providing each of the plurality of parties with an option to discontinue the session prior to achievement of a resolution.

28. A method according to claim 26, the method further comprising:
allowing each of the plurality of parties an option to alter the resolution sequence.

29. A method according to claim 26, wherein the resolution sequence includes at least two of negotiation, mediation, and arbitration.

30. A method according to claim 29, wherein the resolution sequence comprises three stages including negotiation, mediation, and arbitration.

31. A method according to claim 30, wherein the resolution sequence proceeds from a negotiation stage to a mediation stage to an arbitration stage.

32. A method according to claim 31, wherein the negotiation stage is a structured computerized negotiation stage.

33. A method according to claim 32, the method further comprising:
maintaining a computerized transcript of data representative of all communications to or from each of the parties occurring within the session.

34. A method according to claim 33, the method further comprising:
providing the computerized transcript to the structured computerized negotiation stage.

35. A method according to claim 34, the method further comprising:
providing the computerized transcript for by a human mediator use during a mediation stage.

36. A method according to claim 35, the method further comprising:
providing the computerized transcript for use by an arbiter during an arbitration stage.

37. A computer program product for use on a computer system for facilitating agreement pertaining to a situation over a network among a plurality of parties in a session, the computer program product comprising a computer usable medium having computer readable code thereon, the computer readable program code comprising:
computer code for receiving over the network position data, the position data being representative of a position with respect to one or more issues pertinent to a situation, from each of the plurality of parties from the network and storing it in a computer readable medium; and
computer code for providing a plurality of methods of achieving a resolution of the respective positions of each of the plurality of parties.

38. A computer program product according to claim 37, further comprising:
computer code for applying each of the plurality of methods of achieving a resolution in a resolution sequence until an agreement is produced.

39. A computer program product according to claim 37, further comprising:
computer code for monitoring the session and providing each of the plurality of parties with an option to discontinue the session prior to achievement of a resolution.
